(19) United States
(12) Patent Application Publication
(10) Pub. No.: US 2007/0012500 A1
(43) Pub. Date: Jan. 18, 2007

(54) Motorcycle frame and motorcycle

(75) Inventors: Duane Brown, Ravensdale, WA (US); Chris Brown, Auburn, WA (US); Kurt Hall, Olympia, WA (US)

Correspondence Address: SEED INTELLECTUAL PROPERTY LAW GROUP PLLC, 701 FIFTH AVE, SUITE 5400, SEATTLE, WA, 98104, US

(73) Assignee: BBR Motorsports, Inc., Auburn, WA (US)

(21) Appl. No.: 11/447,616

(22) Filed: Jun. 5, 2006

Related U.S. Application Data
(63) Continuation of application No. 29/224,602, filed on Mar. 2, 2005, now Pat. No. D523379.

(51) Int. Cl. B62K 11/00

(52) U.S. Cl. 180/219

(57) ABSTRACT

A motorcycle frame and motorcycle built thereon, the frame having a longitudinal frame assembly with a cradle assembly depending therefrom, the cradle assembly adapted to support rider foot pegs and to provide a lower mount for an engine. The cradle assembly supports the weight of the engine, which is held in a substantially horizontal orientation, and provides a strong support for the rider foot pegs.

### BACKGROUND OF THE INVENTION

1. Field of the Invention

The present invention pertains to motorcycles and motorcycle frames and, more particularly, to a frame adapted to support a horizontally-oriented engine, rider foot pegs, and, when used, at least one foot-actuated brake pedal.

2. Description of the Related Art

Virtually all motorcycles have an engine in which at least one cylinder is oriented either vertically or horizontally. A horizontal four-stroke cylinder engine has a piston stroke that runs parallel or substantially parallel to the ground. As shown in FIG. 1, a convention motorcycle frame 20 is shown in which a four-stroke engine 22 is attached thereto. The frame 20 is a typical backbone-style frame in which the engine 22 is supported at two or three points, one or two at the top 24 of the engine 22 and the other at the back 26 of the engine 22. This frame style has a single or multiple tubes 28 that run longitudinally from a rear swing arm (not shown) located behind the engine 22, up and over the engine 22 to a front head tube 30 where front forks suspension and handle bars are attached. The engine 22 is mounted in such a way that it is suspended or hanging from the frame 20 only by two, three, or four mounting points on the top and back. It has no support or protection at the bottom of the engine 22.

The foot peg bracket 32 on these motorcycles is attached by bolts (not shown) to the bottom of the engine 22 itself and is not supported by the frame 20 in any way. The foot peg bracket 32 (shown in FIG. 2) is part of the motorcycle that the actual foot peg mounts 34 where the foot pegs would be mounted. The foot peg bracket 32 supports nearly 100% of a rider's weight when the rider is standing during riding, and this weight is transferred directly from the foot peg mounts 34 to the foot peg bracket 32 and then to the engine 22. On current horizontal-engine motorcycles, the foot peg bracket 32 is attached to the bottom of the motorcycle engine case 36 by bolts, typically four bolts (not shown). These engine cases 36 are typically made of cast aluminum and are easily broken.

In short, on horizontal-engine motorcycles, the weight of the rider is supported only by the cast aluminum engine cases. Failure can be expensive and dangerous for the owner or rider. This is because many of these horizontal-engine motorcycles are ridden off-road in rough terrain or in competition. When failure occurs on the engine cases where the foot peg bracket 32 is attached, the foot peg mounts 34 and foot peg bracket 32 (typically made of steel) break the bottom of the aluminum motor case 36 and the rider's feet/legs are allowed to contact the ground. This will destroy expensive motor cases and is extremely dangerous for the rider when failure occurs while traveling at any slow speed.

When failure occurs to the engine cases on the suspended motor mounting system (because the engine is suspended from the frame), the engine cases break at the top, allowing the entire engine to break loose from the frame. This destroys expensive engine cases and will cause the rider and the engine to fall to the ground. Not only is this expensive, it is also very dangerous to the rider and to nearby riders.

### BRIEF SUMMARY OF THE INVENTION

A motorcycle frame and corresponding motorcycle are provided in the disclosed embodiments of the invention described herein. In one embodiment of the invention, a motorcycle frame is provided that includes a longitudinal frame assembly and a cradle frame assembly depending from the longitudinal frame assembly and adapted to support rider foot pegs and to provide a bottom engine mount for the engine to hold the engine in a horizontal orientation. It is to be understood that while the present invention is described in the context of a horizontal engine, it will have application to vertically-oriented engines.

In accordance with another embodiment of the invention, a frame for supporting an engine having a reciprocating piston is provided, the frame including a subframe assembly and a frame spar depending from the subframe assembly, the frame spar comprising an engine mount adapted to support the engine such that the piston stroke is within a range of ±45° of horizontal.

In accordance with the foregoing embodiment, at least one foot peg mount is provided, and preferably two. Ideally, the subframe assembly and the frame spar are integrally formed and the subframe assembly includes at least one upper engine mount and the frame spar includes at least one rear engine mount and one lower engine mount.

In accordance with another embodiment of the invention, a frame for supporting a horizontally-oriented engine is provided, the frame includes a mounting assembly and an assembly for holding an engine in a horizontal position, the holding assembly having an association with the mounting assembly. Ideally, the holding assembly includes at least one spar extending from the mounting assembly, and the mounting assembly is adapted to mount at least one from among a fender, a seat, a shock absorber, a gas tank, a fork, and a steering mechanism. The holding assembly is ideally adapted to mount at least one from among a brake pedal, a brake cylinder, at least one foot rest, and a swing arm.

In accordance with another embodiment of the invention, a frame for a motorcycle adapted to support at least one from among a seat, a front wheel fork, a steering mechanism, a swing arm, a fender, a chain roller, a shock absorber, a gas tank, at least one foot rest or foot peg, a brake pedal, a brake cylinder, and an engine having at least one reciprocating piston, the frame including a subframe assembly comprising at least a subframe and at least one side tube; and an engine mount depending from the subframe assembly. Ideally, the engine mount is configured to hold the engine so that the piston reciprocates in a direction at least ±45° of horizontal.

In accordance with another embodiment of the invention, a frame for supporting an engine and at least one foot peg, the frame including a subframe assembly and a cradle depending from the subframe assembly, the cradle adapted to support the engine and to support the at least one foot peg.

In accordance with another embodiment of the invention, a motorcycle is provided that includes a motorcycle frame having a longitudinal assembly and a cradle assembly extending from the longitudinal assembly and adapted to hold an engine and at least one foot peg.

In accordance with another embodiment of the invention, a motorcycle frame for horizontal four-stroke engines is provided that incorporates a structural design and cross-section system that supports the lower side of the engine and strengthens the unsupported and inadequate foot peg mounting bracket by relocating the foot peg stress to the new support structure, thus providing increased durability and safety for horizontal engine motorcycles. The motorcycle frame includes a unique frame structure and cross-section system designed to support the lower side of a horizontal engine and to strengthen the foot peg mounting bracket by relocating the foot peg stress to the new support structure. Thus, the unique frame design combines the mounting of the engine through a foot peg cross-section to the frame.

As will be readily appreciated from the foregoing, the frame of the present invention and resulting motorcycle corrects both of the issues listed above by supporting the horizontal four-stroke engine from the bottom and incorporating the foot peg bracket mounting system through the frame itself. This adds durability and safety by the nature of its design. More particularly, this design maintains the correct relationship of the engine to the critical meeting components, such as the rear sprocket, rear brake system, brake pedal, kick-starter arm, rear shock absorber, engine system, and other components, including the drive chain or drive belt.

The frame design and motorcycle of the present invention provide improved engine support by incorporating an additional engine support location that cradles the lower side of the engine. This additional mounting point substantially reduces weight stress on the upper motor mounts by distributing the weight stress to the new lower engine mount in the cradle, eliminating the “suspended” engine position. Thus, the weight of the engine and the motorcycle rider are supported by the frame as the new design allows the engine to sit upon and be bolted to the new support system that is incorporated in the structure of the frame itself. The combined engine and rider weight are no longer suspended only by mounting points from the top of the engine. The new frame allows the weight of the engine and the rider to now be supported from below in addition to from above, which protects the engine from dropping to the ground should the upper motor mounts fail.

In addition to support for the engine, the frame design of the present invention incorporates the foot peg mounting system into the same frame support system. The new design can use the existing foot peg bracket or eliminate the bracket altogether. Due to the engine support by the new frame of the present invention, the stress is minimized on the engine cases, which is normally caused by the weight of the foot peg mounts because the foot peg bracket is now mounted through the frame instead of only to the engine. The new frame design of the present invention also utilizes the mounting holes in the engine case where the foot peg mount is traditionally bolted to the engine case. A new cross-section plate is supported by the new frame structure from the sides, creating a solid structure for both the engine and the foot pegs because both are now attached directly to the frame. The entire foot peg structure is now supported by the mounting plate bolted to the engine cases through the frame and is supported by the frame structure itself.

In order to incorporate the structure engine and foot peg support, the entire frame of the present invention has been engineered from the head-tube to the subframe assembly as described in more detail below. Thus, the frame design of the present invention and resulting motorcycle provide improved durability, fewer problems with expensive broken motor mounts and damaged engine cases, and improved rider safety by reducing the risk of failure that may result in injury to the rider.

### BRIEF DESCRIPTION OF THE SEVERAL VIEWS OF THE DRAWINGS

FIG. 1 is a side view of a traditional backbone-style motorcycle frame with engine;

FIG. 2 is a bottom plan view of the traditional motorcycle frame and engine of FIG. 1;

FIG. 3 is an isometric projection from a top side view of a motorcycle frame formed in accordance with one embodiment of the present invention;

FIG. 4 is a top plan view thereof;

FIG. 5 is an elevational front view thereof;

FIG. 6 is an elevational rear view thereof;

FIG. 7 is an elevational view of a first side thereof;

FIG. 8 is an elevational view of a second side thereof;

FIG. 9 is a bottom plan view thereof;

FIG. 10 is an isometric projection of another embodiment of a motorcycle frame formed in accordance with the present invention;

FIG. 11 is a side view of the embodiment of FIG. 10 showing an engine mounted thereon;

FIG. 12 is a partial enlarged view of the frame and engine of FIG. 11;

FIG. 13 is a bottom plan view of the frame and engine assembly of FIG. 11;

FIG. 14 is an isometric projection of a top side view of another embodiment of a motorcycle frame formed in accordance with the present invention;

FIG. 15 is a top plan view thereof;

FIG. 16 is an elevational front view thereof;

FIG. 17 is an elevational rear view thereof;

FIG. 18 is an elevational view of a first side thereof;

FIG. 19 is an elevational view of a second side thereof; and

FIG. 20 is a bottom plan view thereof.

### DETAILED DESCRIPTION OF THE INVENTION

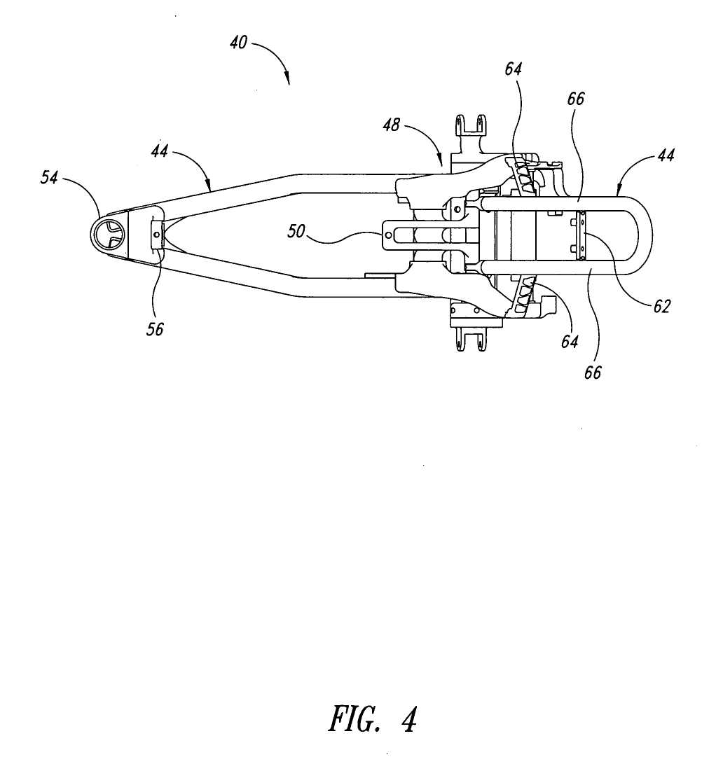

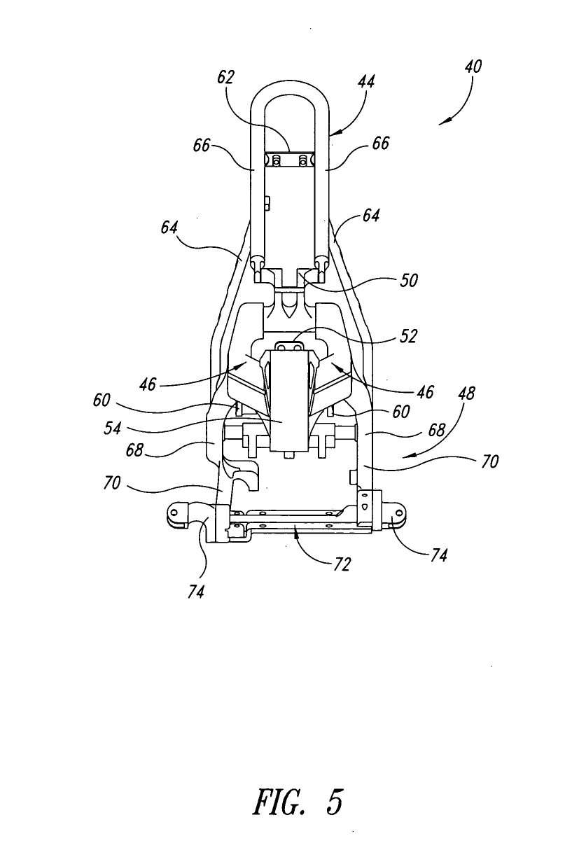

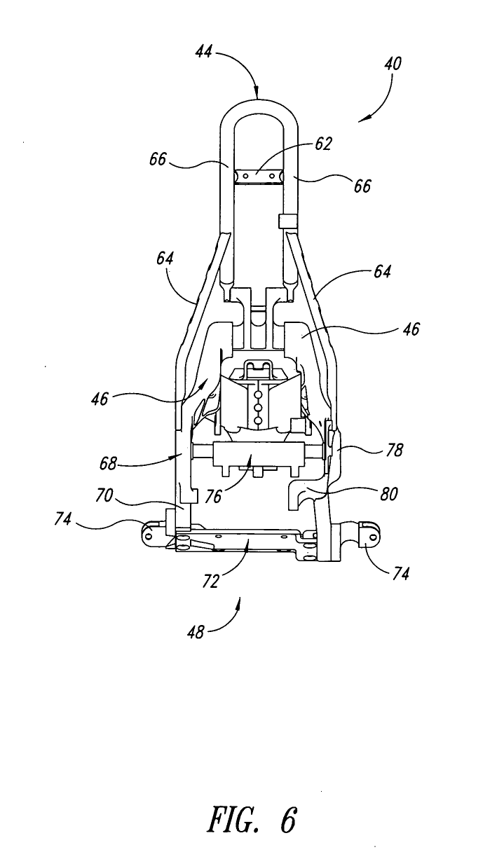

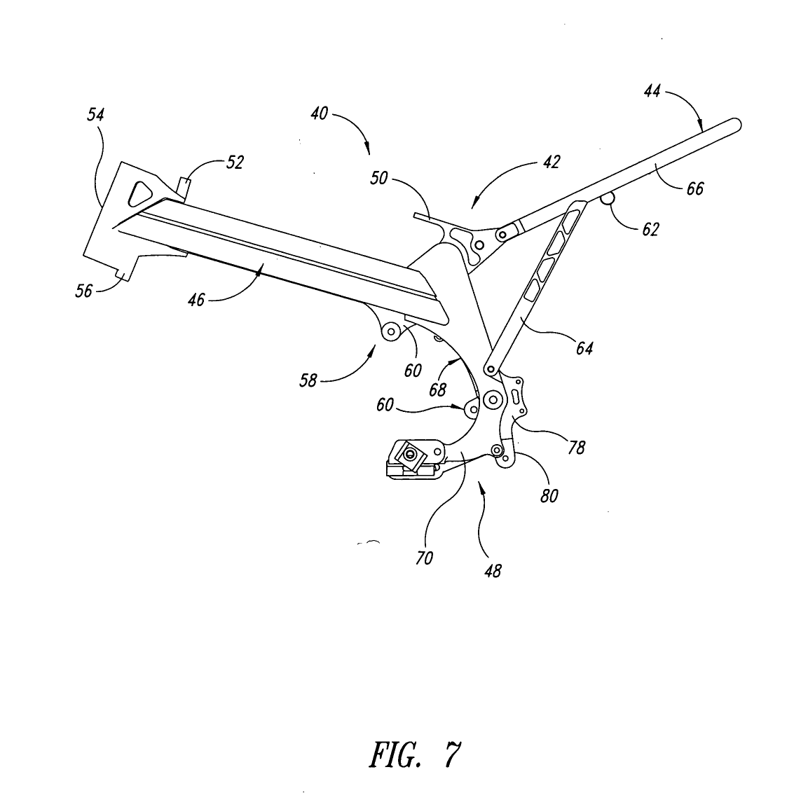

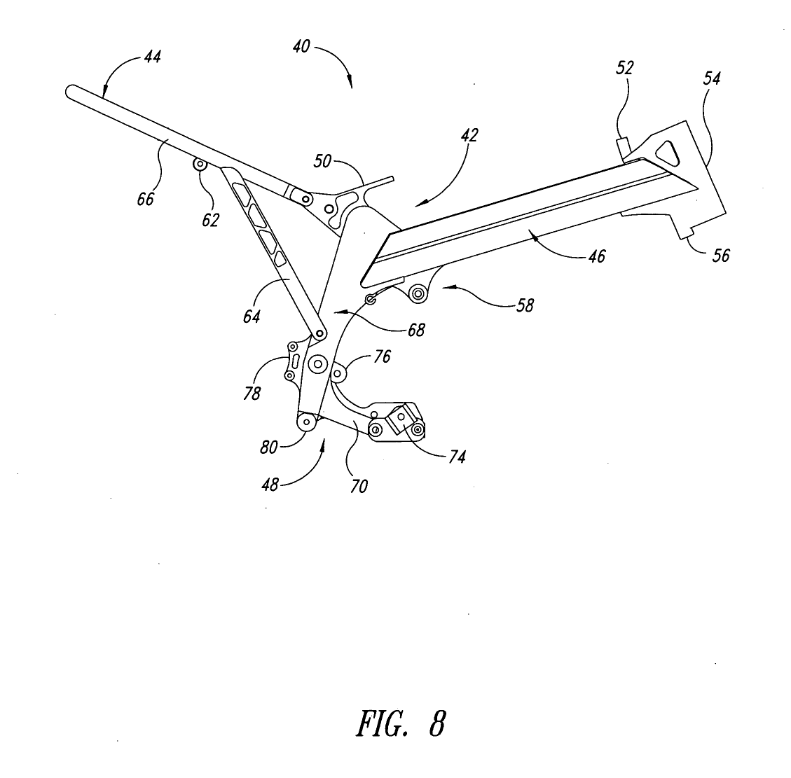

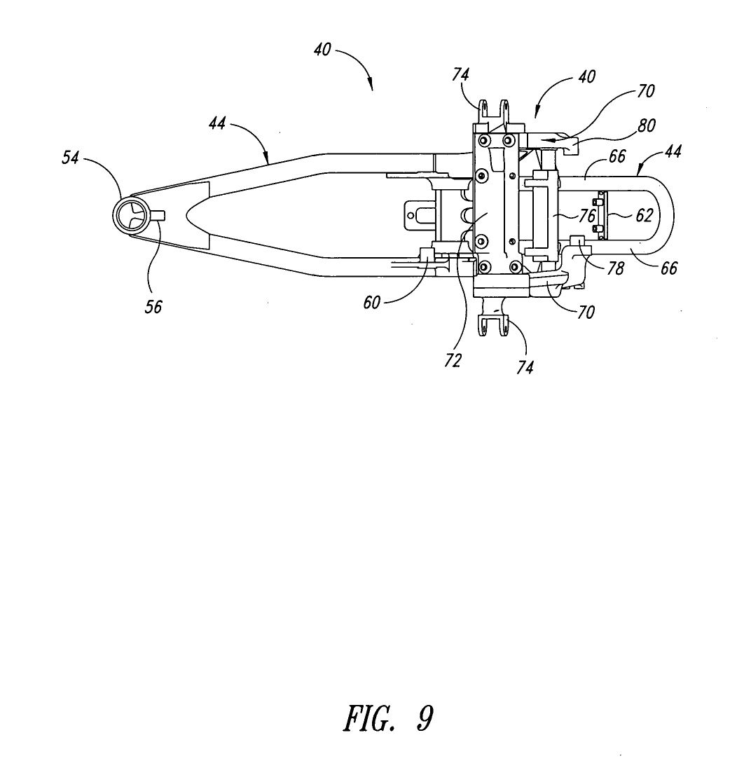

A representative embodiment of the present invention will now be described in conjunction with FIGS. 3-9. As shown therein, a frame 40 that, in this embodiment, has a longitudinal frame assembly 42 that includes a subframe 44 and perimeter side tubes 46 attached to or formed with a cradle assembly 48. As shown in this embodiment, the subframe 44 is attached to a rear gas tank mount 50 that in turn is coupled to the cradle assembly 48. A forward gas tank mount 52 is located behind a head tube 54 at a forward end of the side tubes 46. Depending from the head tube 54 is a steering stop 56. An upper engine mount 58 in the form of a pair of lugs 60 extends from the cradle assembly 48 where the side tubes 46 meet the cradle assembly 48. A rear fender mount 62 is located on the U-shaped subframe 44, and a brace 64 for the subframe 44 extends from both sides 66 of the U-shaped subframe 44 down to the cradle assembly 48.

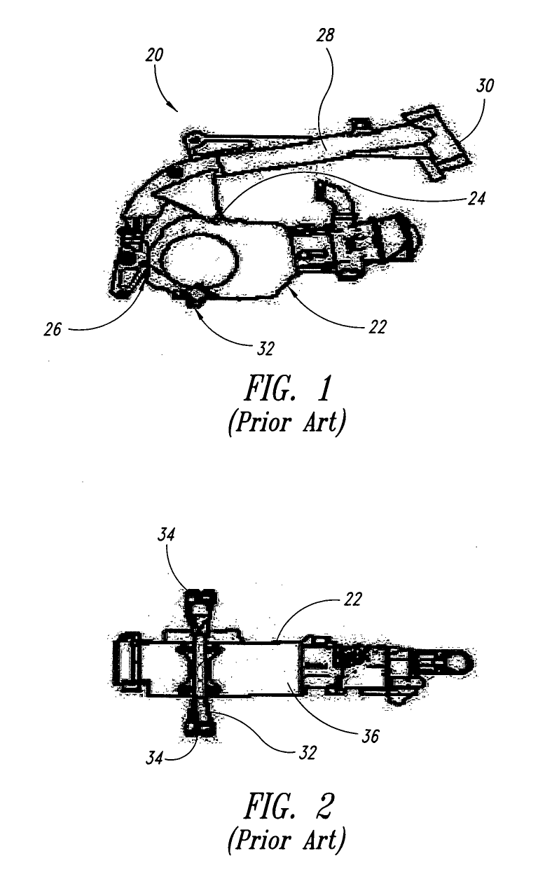

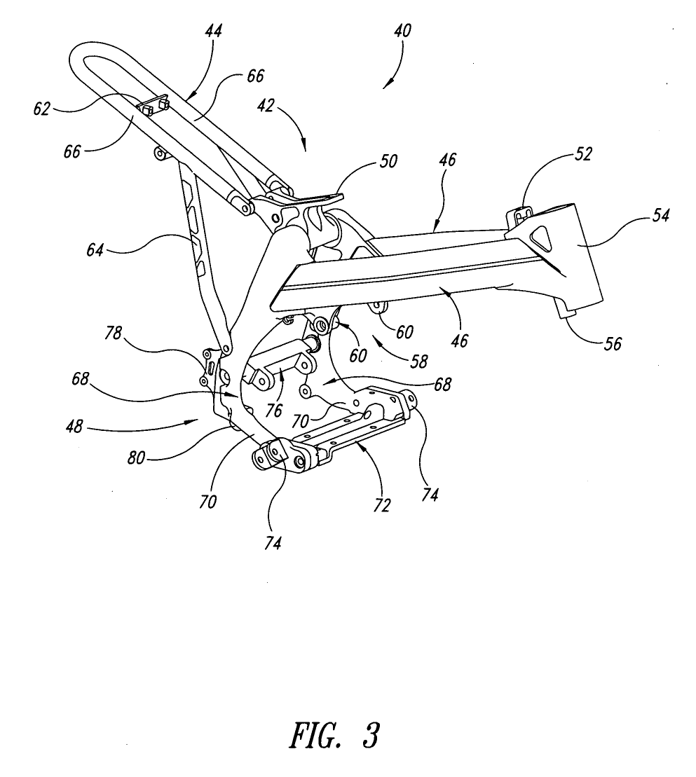

The cradle assembly 48 is, in this embodiment, formed of a pair of frame spars 68 that, as shown in FIG. 1, extend away from the longitudinal frame assembly 42 and have a pair of legs 70 that curve toward the front in the direction of the head tube 54. Attached to each frame spar 68 is the brace 64. In addition, a lower engine mount 72 is located at a distal end of the frame spar legs 70. Foot peg mounts 74 are shown attached to the legs 70. Alternatively, the lower engine mount 72 may be integrally formed with the foot peg mounts 74 or attached with the separate foot peg mounts using the same fastener or other suitable hardware or by welding or other known methods. In another embodiment, foot pegs can be mounted directly to the legs or to the lower engine mount or both without using a foot peg mount. Another method is to attach the foot peg mount 74 through the leg 70 and into the engine case, although that is not preferred due to risk of damage to the engine case. In one embodiment, the foot peg mounts 74 extend through the frame spar legs 70 into the lower engine mount 72, and the lower engine mount 72 is attached to each leg 70 with two bolts. The foot pegs themselves are then mounted to the foot peg mounts 74 with a pin and clip (not shown) as is known in this technology.

A rear engine mount 76 is shown positioned between the frame spars 68 in such a manner that it is “floating.” In other words, the rear engine mount 76 is not attached directly to the frame spars 68, but instead is dimensioned to have a width less than the width between the frame spars 68 to create a space for the insertion of a rear swing arm (not shown) to which is mounted the rear wheel of the motorcycle. The rear engine mount is considered optional in some embodiments, providing additional stability to the mounting of the engine.

The legs 70 of the frame spars 68 are designed to curve forward, and the degree of projection and the amount of curvature between the legs 70 and the upper portion of the frame spar 68 is a matter of design, as is the exterior configuration of the frame spars 68. The position of the lower engine mount 72 on the legs 70 can be made adjustable to position the engine at a desired horizontal orientation in the range of ±45° from horizontal. A preferred range is, in one embodiment, between ±10°, and in another embodiment between ±5° of horizontal. It is to be understood that other ranges, such as ±15°, ±20°, ±25°, ±30°, and ±35° may also be used depending on the engine style and size, and the nature of the use of the motorcycle.

In addition to the foregoing, the cradle assembly 48 also includes a rear brake master cylinder mount depending from one of the frame spars 68, in this case from the right frame spar as shown in FIG. 3. A brake pedal mount 80 for a foot-actuated brake pedal (not shown) is also formed on the cradle assembly 48, and as shown in FIGS. 3-9, is associated with the right frame spar 68. The brake pedal mount 80 can be associated or formed to be integral with the brake cylinder mount 78.

In construction, the frame is preferably formed of metal, such as aluminum, chromoly, steel, or other metal or a combination thereof, with each assembly component welded together to form a rigid structure. However, it is to be understood that other methods of attachment may be used, including fasteners, tightly-fitted joints, and other methods known to those skilled in the art.

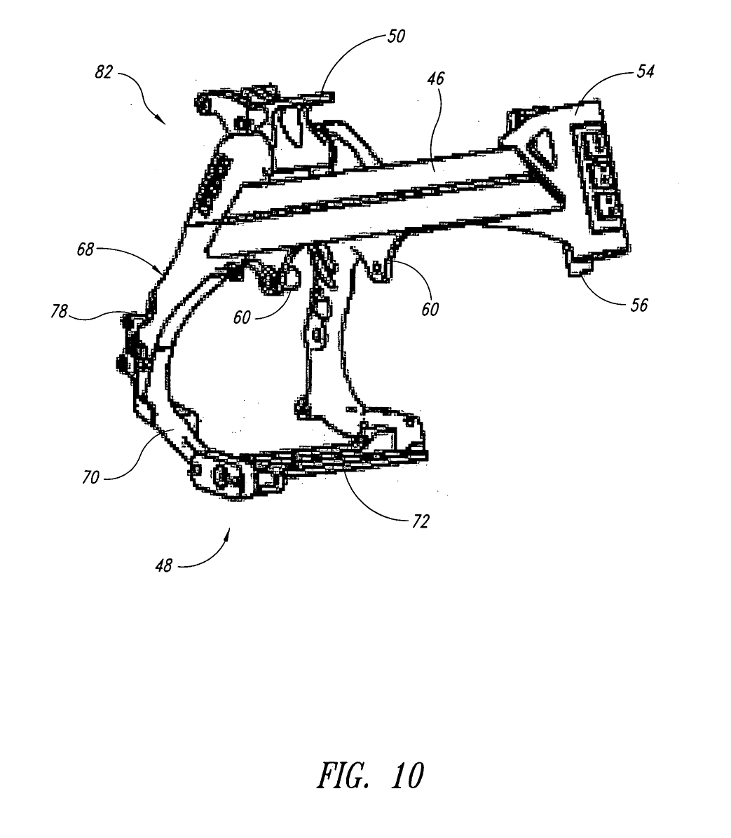

FIG. 10 illustrates an alternative embodiment in which the subframe 44 and brace 64 are not shown. In addition, the foot peg mounts 74 are also not shown on the cradle assembly 48.

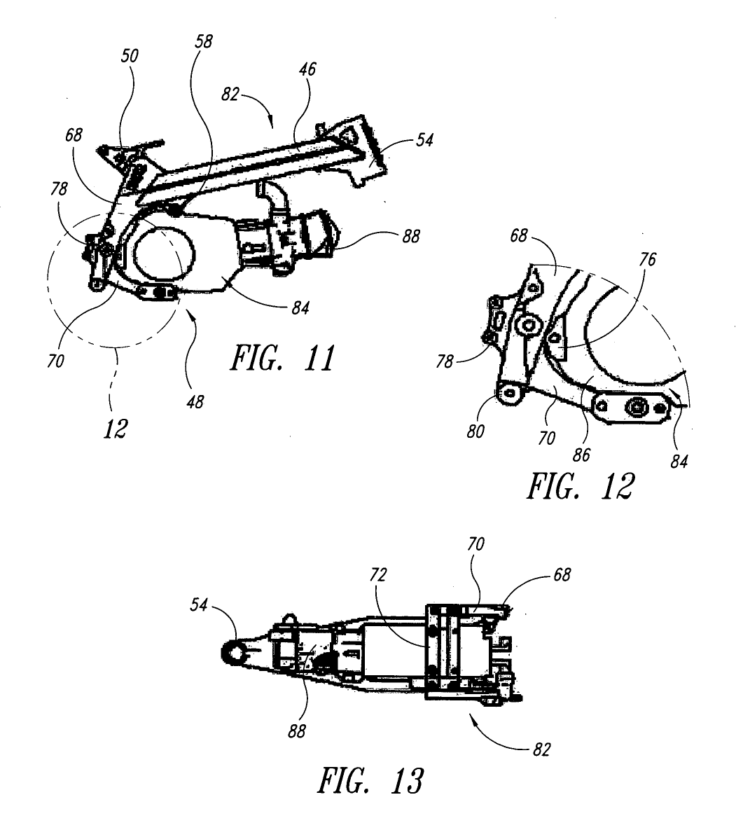

FIGS. 11-13 illustrate the frame 82 of FIG. 10 having an engine 84 mounted thereon. For ease of reference and sake of simplicity, the same reference numbers are used for common components among the different embodiments. Here, the engine casing 86 is attached to the lower engine mount 72 and the upper engine mount 58. In addition, as an optional mounting, the rear engine mount 76 can also be used as shown in FIG. 12. As can be seen in FIG. 11, the cylinder head 88, in which a piston is mounted to reciprocate, is oriented substantially in a horizontal position. This means relatively horizontal with respect to the earth.

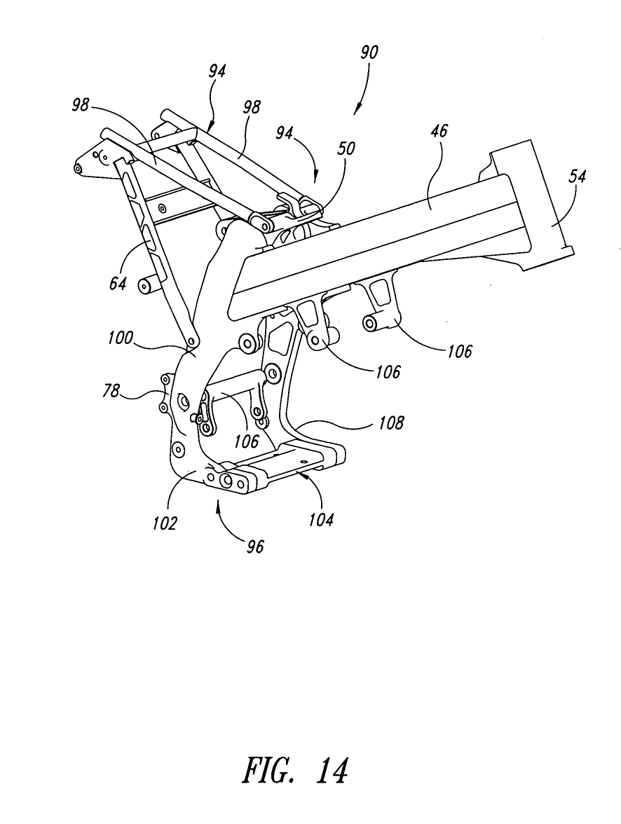

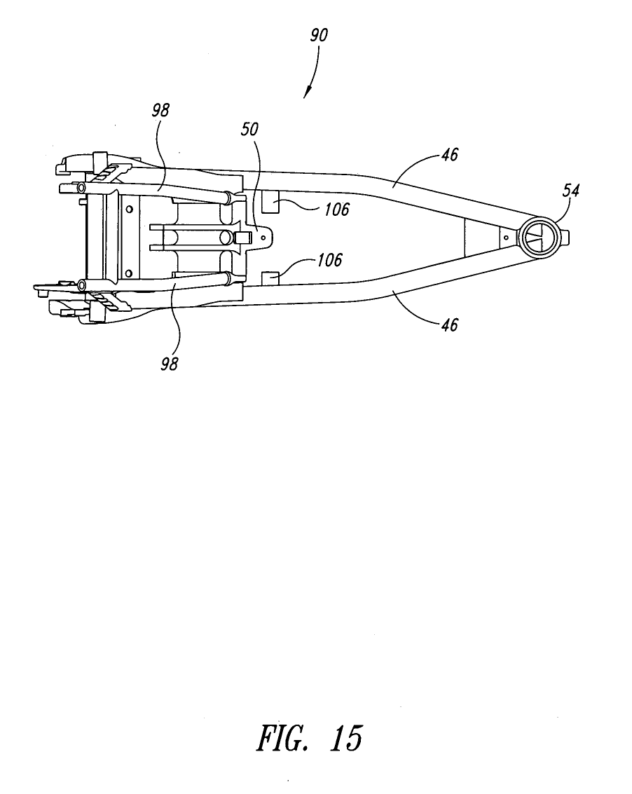

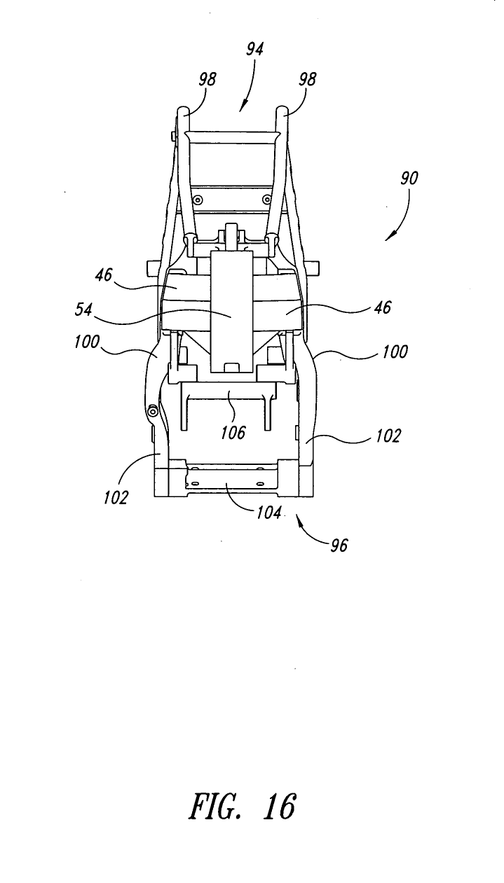

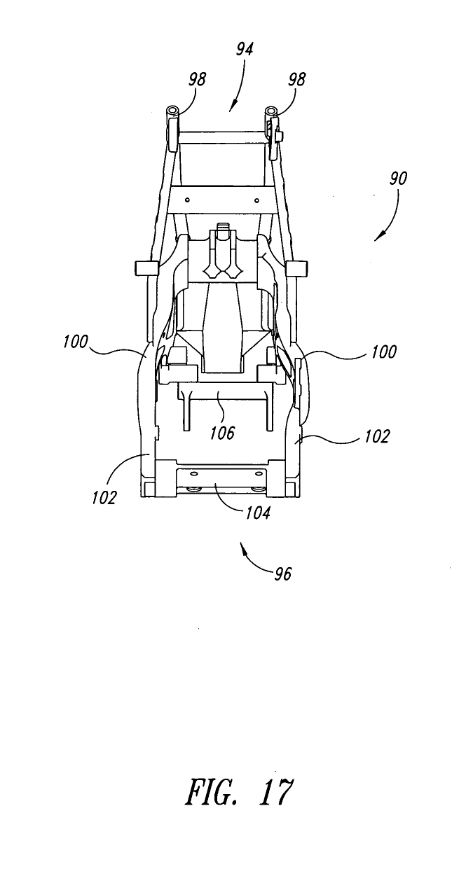

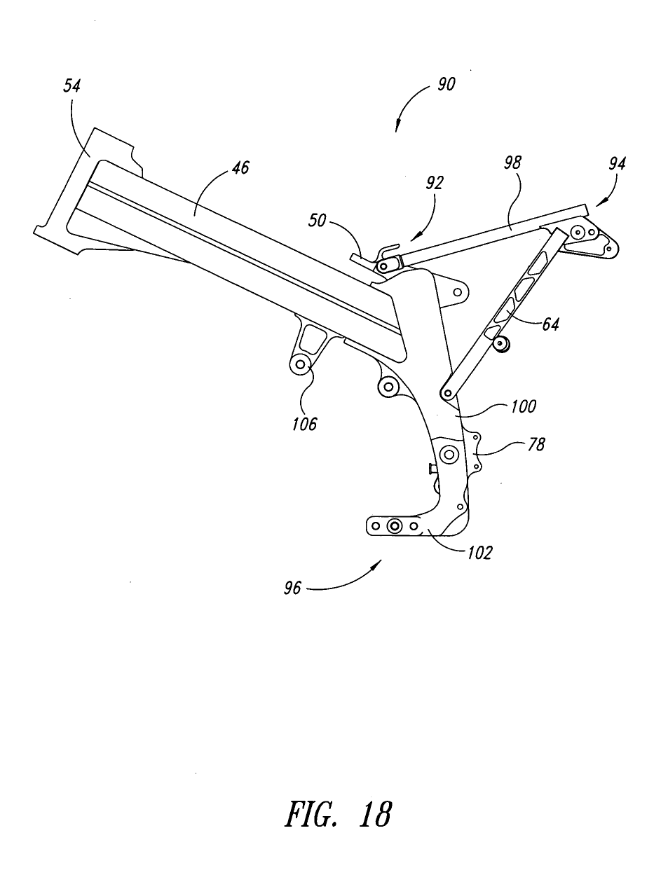

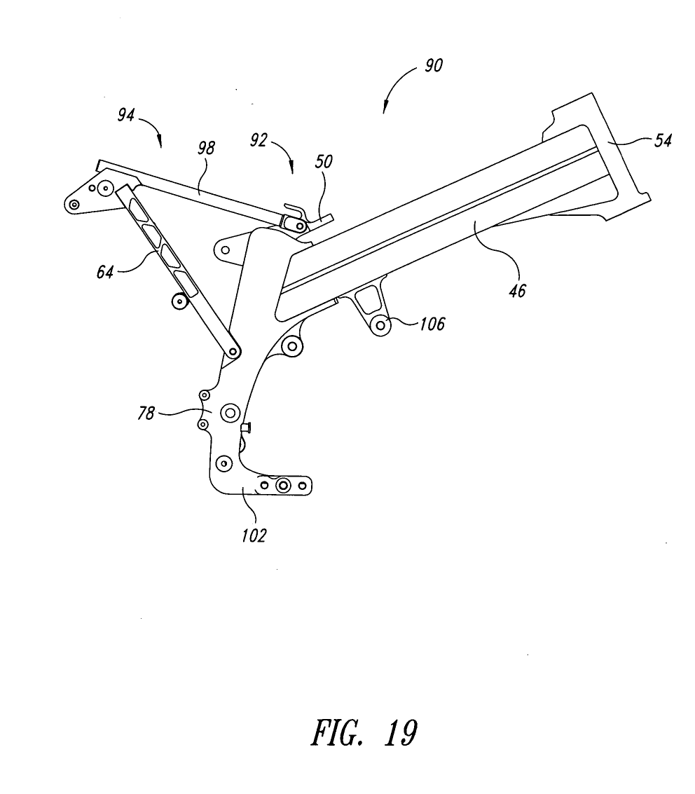

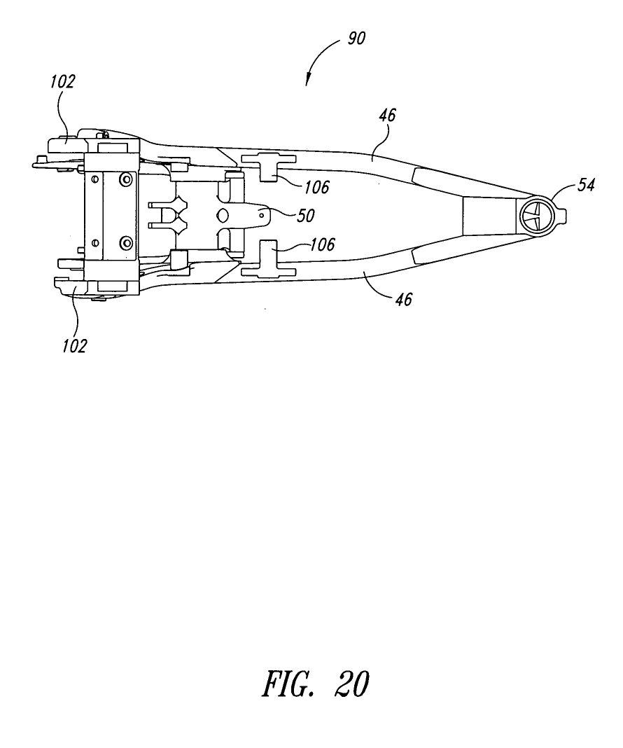

FIGS. 14-20 illustrate yet another embodiment of the invention. For ease of reference, elements common to the other embodiments will bear the same reference numbers.

As shown in these FIGS. 14-20, a motorcycle frame 90 is presented similar in some respects to the appearance and function of the motorcycle frames 40 and 82 previously described. This third embodiment includes a longitudinal frame assembly 92 having a modified subframe 94 and the perimeter side tubes 46 coupled to the cradle assembly 96. The subframe 94 in this design utilizes a pair of rails 98, preferably tubular in shape, although other shapes may be used to accomplish the same purpose. The rails are attached to the rear gas tank mount 50. The brace 64 extends from the subframe 94 to the cradle assembly 96, and in particular to the frame spars 100 that have lower legs 102 depending therefrom. The legs 102 extend toward the front or head tube 54 to be positioned below the side tubes 46. A lower engine mount 104 is positioned between the distal end of the legs 102. A rear engine mount 106 is shown floating between the frame spars 100 in a manner described previously with respect to the motorcycle frame 40 and the rear engine mount 76. A pair of upper engine mounts 106 depend from the side tubes 46.

In this embodiment, the motorcycle frame 90 is sized to accommodate a different engine (not shown). Thus, the length of the frame spars 100 and legs 102 will, for the most part, be dictated by the size of the engine. However, the particular shape of the frame spars 100 and legs 102 is a matter of design choice, including the arc of curvature of the legs 102 at the intersection 108 with the upper portion of the frame spars 100, the rounded nature of the exterior surface of the frame spars 100 and legs 102, as well as of the side tubes 46, the subframe 94, and the braces 64. It is to be understood that other aesthetic shapes may be used without compromising the structural integrity of the frames described herein.

Foot pegs (not shown) may be mounted directly to the ends of the legs 102. Although separate foot peg mounts are not shown in connection with this embodiment of the invention, it is to be understood that foot pegs mounts 74 used with the first frame 40 may be mounted on the outside of the legs 102. And as with the previous embodiments, each of the components may be coupled together via welding, fasteners, tight fit junctions, and other methods known to those skilled in the art.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A motorcycle frame for supporting a horizontal reciprocating engine, comprising:
a longitudinal frame assembly; and
a cradle frame assembly depending from the longitudinal frame assembly and adapted to support rider foot pegs and to provide a bottom engine mount for the engine.

2. The motorcycle frame of claim 1 wherein the cradle frame assembly comprises a pair of frame spars extending from an upright member, the frame spars adapted to support the rider foot pegs and to provide a lower mount for the engine to hold the engine in a horizontal orientation.

3. The motorcycle frame of claim 1 wherein the cradle frame assembly is adapted to support a brake pedal, right and left foot peg mounts, right and left foot pegs, and a lower engine mount.

4. The frame of claim 3, further comprising a rear engine mount adapted for mounting on the cradle frame assembly to rotate about a transverse axis, and wherein the longitudinal frame assembly comprises at least one upper engine mount.

5. A frame for supporting an engine having at least one reciprocating piston and at least one foot peg, the frame comprising:
a subframe assembly; and
a frame spar depending from the subframe assembly, the frame spar comprising an engine mount adapted to support the engine such that the piston stroke is within a range of ±45° of horizontal.

6. The frame of claim 5 wherein the frame spar comprises at least one foot peg mount.

7. The frame of claim 5 wherein the subframe assembly and the frame spar are integrally formed.

8. The frame of claim 5, comprising at least one upper engine mount on the subframe assembly.

9. The frame of claim 5, comprising at least one rear engine mount on the frame spar.

10. The frame of claim 9 wherein the frame spar comprises first and second legs, each leg having a free end adapted to receive the respective foot peg and a lower engine mount coupled to the left and right legs.

11. A frame for supporting an engine in a horizontally-oriented position and at least one foot peg, the frame comprising:
means for mounting; and
means associated with the mounting means for holding the engine in the horizontally-oriented position.

12. The frame of claim 11 wherein the holding means comprises at least one spare extending from the mounting means.

13. The frame of claim 11 wherein the mounting means is adapted to mount at least one from among a fender, a seat, a shock absorber, a steering mechanism, a front wheel fork, and an exhaust component.

14. The frame of claim 11 wherein the holding means is adapted to mount at least one from among a brake pedal, a brake cylinder, at least one foot peg, a swing arm, and at least one lower engine mount.

15. The frame of claim 11 wherein the holding means and the mounting means are integrally formed.

16. A frame for a motorcycle adapted to support at least one from among a seat, a front wheel fork, a steering mechanism, a swing arm, a fender, a chain roller, a shock absorber, a gas tank, at least one foot rest, at least one foot rest mount, a brake pedal, a brake cylinder, and an engine having at least one reciprocating piston, the frame comprising:
a subframe assembly comprising at least a subframe and at least one side tube; and
an engine mount depending from the subframe assembly, the engine mount configured to hold the engine so that the piston reciprocates in a direction at least ±45° of horizontal.

17. The frame of claim 16 wherein the engine mount comprises a foot peg mount for receiving at least one foot peg.

18. The frame of claim 16 wherein the engine mount comprises a brake pedal mount for mounting a foot-actuated brake pedal.

19. A frame for supporting an engine and at least one foot peg, the frame comprising:
a subframe assembly; and
a cradle depending from the subframe assembly, the cradle adapted to support the engine and to support the at least one foot peg.

20. The frame of claim 19 wherein the cradle is adapted to support a pair of foot pegs and a foot-actuated brake pedal.

21. The frame of claim 19 wherein the subframe assembly comprises at least one upper engine mount, and the cradle depends from the subframe assembly and comprises at least one lower engine mount.

22. The frame of claim 21 wherein the cradle and lower engine mount are adapted to support the engine in a substantially horizontal orientation.

23. The frame of claim 21 wherein the cradle is adapted to support the engine so that a piston reciprocates in the engine within ±45° of horizontal.

24. A motorcycle, comprising:
a motorcycle frame having a longitudinal assembly and a cradle assembly extending from the longitudinal assembly and adapted to hold an engine and at least one foot peg.

25. The motorcycle of claim 24 wherein the cradle is adapted to hold the engine so that a piston reciprocates in the engine in a direction substantially parallel to horizontal.

26. The motorcycle of claim 24 wherein the cradle is adapted to support an engine so that a piston reciprocates in the engine in a direction within ±45° of horizontal.

27. The motorcycle of claim 24 wherein the cradle is adapted to support at least two foot pegs and a foot-actuated brake pedal.
